(19) United States
(12) Patent Application Publication
(10) Pub. No.: US 2004/0268068 A1
(43) Pub. Date: Dec. 30, 2004

(54) Efficient method for copying and creating block-level incremental backups of large files and sparse files

(75) Inventors: Robert J. Curran, West Hurley, NY (US); Wayne A. Sawdon, San Jose, CA (US); Frank B. Schmuck, Campbell, CA (US)

Correspondence Address: Lawrence D. Cutter, Attorney, IBM Corporation, Intellectual Property Law Dept., 2455 South Rd., M/S P386, Poughkeepsie, NY, 12601, US

(73) Assignee: INTERNATIONAL BUSINESS MACHINES CORPORATION, Armonk, NY

(21) Appl. No.: 10/602,159

(22) Filed: Jun. 24, 2003

(51) Int. Cl. G06F 12/00

(52) U.S. Cl. 711/162

(57) ABSTRACT

Data structures are provided for file systems to facilitate backup processes that are especially useful for large and/or sparse data files. In one aspect of the invention, these data structures include time stamp information that is accessible for use by a system user at the application program level. These data structures also include indications of current validity that reduce the need to perform I/O operations which are naturally very resource intensive for large files. The ability to incorporate efficiencies accorded to files having blocks designated as being sparse is also provided. The incorporation of these data structures in the file system itself permits the backup process to be not only incremental in nature but also to be directed at the file level as opposed to, say, the disk level.

### BACKGROUND OF THE INVENTION

The present invention is generally directed to a method and system for copying and creating incremental, block level backups of large and/or sparse files in data processing systems. More particularly, the present invention employs extended, user accessible read and write operating system calls which enable users to retrieve incremental changes that occur between specified times. Even more particularly the present invention allows users to explicitly specify the size and location of holes in the file (that is, sparse data) so that the file system is permitted to de-allocate space used to store prior versions of any data stored in those file locations. While the current invention is described in terms of its use in disk based data storage systems, its use is not limited to such systems.

To protect data from catastrophic failures, many file systems keep a copy of the data in a second location, perhaps in another storage device, in another storage type or even in another building. In order to properly maintain this backup copy of the data, a file system often identifies changes made to the original data and then incrementally applies these changes to the backup copy. In most cases, the amount of data that changes between each backup period is relatively small compared to all of the data stored in the file system. By applying only the incremental changes, the overhead for maintaining the backup copy of the data is greatly reduced.

In many systems, the backup is done by utility programs, such as the UNIX “dump,” “tar,” or “rdist,” that backup the entire file even if only a single byte in the file has changed. Other backup programs, such as “rsync,” use heuristic algorithms to determine the portions of the blocks that have changed. Some specialized systems, such as a database, mirrored snapshot file system or a disk array, can determine the changed blocks, but at the level of the entire database or file system or disk. Furthermore, these operations are restricted to internal backup utilities and are not exported for general use. Thus an individual user backing up his own data must rely upon a more costly technique.

Another opportunity to reduce the overhead of creating and maintaining file copies exists when a file is “sparse,” that is, when not all of the data blocks of the file have been written to. An X-Open compliant file system, for example, allows the user to write data to an arbitrary location in a file. Unwritten portions of the file, when read return zeros for the data. Many file systems do not actually store the zeros. Instead, the file system recognizes the unwritten area in the file and simply supplies zeros to any read request. This reduces the storage required for the file and reduces the time necessary to read the file by eliminating the I/O (Input/Output) requests to the storage device.

Application level programs reading sparse files still see all of the zeros. Unfortunately, even though the file system “knows” that there is no data, it has no means of informing the application. Thus, the application program must read over the sparse areas. For some applications, such as a file backup program or even a simple file copy program, reading the zeroes is a waste of time and is also a potential waste of space to store the zeroes at the destination. This is a major aspect of the problems solved by the present invention.

Unfortunately, even though the file system knows precisely which portions of the file contain non-zero data, there is no means of informing the application. Thus, traditional implementations of utilities like “cp” and “tar,” for example, actually read all of the zeros from their input files and write them to the destination device, resulting in unnecessary storage overhead and disk/network traffic in order to create and maintain file copies. Some implementations of “cp” and “tar” (for example, the GNU versions of these utilities) use heuristic methods to detect sparse regions in a file being read and to thus avoid writing blocks of zeros to the destination file. However, these utilities must still scan through all of the zeros to find the non-zero data. Even though no disk I/O is required to do so, CPU time and memory bandwidth overhead can be prohibitive. For modern file systems that support file sizes up to 264 bytes, scanning the zeros in a large sparse file is impractical.

There are a variety of methods that are available for backup programs to identify changed blocks without support from the file system. However, these methods generally rely on heuristic data signatures to determine if the blocks have changed. Additionally, these signatures must be stored with the backup copies or must regenerated for each backup.

Many file systems also support sparse files, but few make this information available to application programs. One system that exports this information is the Novell Netware file system, but this system exports this information in the form of an allocation bit map, which is proportional in size to the size of the file, not the size of the actual non-zero data in the file. Hence it does not scale to large sparse files (264 bytes). Other programs like “cp” and “tar” rely on heuristics to identify sparse files. Although the heuristics may reduce the amount of I/O, the program must still scan all zeroed data to locate the non-zero portions of a file.

Incremental block-level differencing is used in a number of areas. For example, in database systems, the data blocks that have changed are identified by a Log Sequence Number (LSN) stored in each block. A global LSN is incremented with every update and each block stores the LSN of its most recent update. This allows the database system to determine exactly the blocks that have changed since any point in time. Unfortunately, only the files that contain the database can benefit from this technique. Furthermore, the database must read all of the data blocks to determine those that have changed.

As another example, disk arrays and some disk subsystems maintain a bit map for each block stored on a disk. The disk controller sets the corresponding bit in the bit map for each block written. A backup program scans the bit map to determine the blocks that have changed since the last time backup ran. Unfortunately, the bit map applies to the entire disk and only to the one disk. This prohibits the disk from being partitioned and used in more than one file system. Furthermore, there is no easy way to correlate the data blocks in a single file to the set of bits in the disks used to store that file, in particular when the file has been striped across a range of disks.

In yet another example, file systems that support snapshots, such as Network Appliance, support incremental block level differencing in one of their products. Unfortunately, the bit maps used for this product, like the bit maps in disk arrays, apply to all of the data, making it difficult to determine the exact blocks within a single file. Furthermore, this differencing information is used only internally and is not available for general use.

In contrast, the present invention provides a method for general users to efficiently retrieve non-sparse data as well as to retrieve the incremental differences in one or more files. Two new extended operating system level instruction calls are provided for reading and for writing changed data. The extended read call employs two time stamps and returns the incremental changes between them. When reading into a sparse region of a file, the call returns data only up to the beginning of the sparse region plus an indication of the length of the region. This allows an application to skip over the sparse region without explicitly reading zeros. The second extended call is an extended write call which allows the user to explicitly specify holes in the file so as to allow the file system to de-allocate unnecessary blocks. The programming interface for the extended read call and extended write calls are shown below in the Appendix.

For a better understanding of the environment in which the present invention is employed, the following terms are employed in the art to refer to generally well understood concepts. The definitions provided below are supplied for convenience and for improved understanding of the problems involved and the solution proposed and are not intended as implying variations from generally understood meanings, as appreciated by those skilled in the file system arts. Since the present invention is closely involved with the concepts surrounding files and file systems, it is useful to provide the reader with a brief description of at least some of the more pertinent terms. A more complete list is found in U.S. Pat. No. 6,032,216 which is assigned to the same assignee as the present invention. This patent is hereby incorporated herein by reference. The following glossary of terms from this patent is provided below since these terms are the ones that are most relevant for an easier understanding of the present invention:

Data/File system Data: These are arbitrary strings of bits which have meaning only in the context of a specific application.

File: A named string of bits which can be accessed by a computer application. A file has certain standard attributes such as length, a modification time and a time of last access.

Metadata: These are the control structures created by the file system software to describe the structure of a file and the use of the disks which contain the file system. Specific types of metadata which apply to file systems of this type are more particularly characterized below and include directories, inodes, allocation maps and logs.

Directories: These are control structures which associate a name with a set of data represented by an inode.

Inode: A data structure which contains the attributes of the file plus a series of pointers to areas of disk (or other storage media) which contain the data which make up the file. An inode may be supplemented by indirect blocks which supplement the inode with additional pointers, say, if the file is large.

Allocation maps: These are control structures which indicate whether specific areas of the disk (or other control structures such as inodes) are in use or are available. This allows software to effectively assign available blocks and inodes to new files. This term is useful for a general understanding of file system operation, but is only peripherally involved with the operation of the present invention.

Logs: These are a set of records used to keep the other types of metadata in synchronization (that is, in consistent states) to guard against loss in failure situations. Logs contain single records which describe related updates to multiple structures. This term is also only peripherally useful, but is provided in the context of alternate solutions as described above.

File system: A software component which manages a defined set of disks (or other media) and provides access to data in ways to facilitate consistent addition, modification and deletion of data and data files. The term is also used to describe the set of data and metadata contained within a specific set of disks (or other media). While the present invention is typically used most frequently in conjunction with rotating magnetic disk storage systems, it is usable with any data storage medium which is capable of being accessed by name with data located in nonadjacent blocks; accordingly, where the terms “disk” or “disk storage” or the like are employed herein, this more general characterization of the storage medium is intended.

Timestamp: A monotonically increasing counter to represent the passage of time. A variety of implementations are possible, a single “dirty” bit, a Log Sequence Number (LSN), a Snapshot Identifier, or possible the actual time of day. Though certainly not preferred it is also possible to implement the timestamp function with a monotonically decreasing counter.

Snapshot: A file or set of files that capture the state of the file system at a given point in time.

Metadata controller: A node or processor in a networked computer system (such as the pSeries of scalable parallel systems offered by the assignee of the present invention) through which all access requests to a file are processed. This term is provided for completeness, but is not relevant to an understanding of the operation of the present invention.

### SUMMARY OF THE INVENTION

In accordance with a preferred embodiment of the present invention, a method for performing block level incremental backup operations for a file, especially for a large and/or sparse file comprises the steps of: backing up the said file to create a backup copy of the file and/or working with an existing backup copy; processing a write request relevant to one or more blocks of the file by storing the changes in information for the file and by providing an indication that the information stored in any of the blocks is new data; and backing up the file from the block or blocks selected as having an indication that information they hold is new data.

In accordance with another preferred embodiment of the present invention, a method for retrieving incrementally backed up block level data, especially from large and/or sparse files, comprises the steps of: supplying two time stamps to a file system in a read request; and returning information with respect to changes in said block made between times indicated by said two time stamps. As a part of this process, read requests to areas of the file which are indicated as having null block addresses result in an indication that this is a sparse portion of the file.

Also, another embodiment provides a method for retrieving all of the non-zero data in a sparse file (as opposed to the incremental changes only). In this embodiment the user does not need to provide the timestamps. In this regard it is noted that the example calls shown in the Appendix accept a NULL pointer for the timestamps to indicate the call should return all of the non-zero data, as opposed to only the changed non-zero data.

It is to be particularly noted that the present invention supports the writing of incremental changes to a prior, backup copy of a file. Writing includes the ability to write a hole into the destination file.

For purposes of both reading and writing, the methods of the present invention typically supply zero values for sparse file locations. However, values other than zero may be employed, as for example in the case of text data where the value “40” (hexadecimal) may be returned indicating a blank space. Other values may be employed in other circumstances; additionally, either user supplied or predetermined default values may be inserted in regions which are indicated as being sparse.

Accordingly, it is an object of the present invention to provide a mechanism for backing up large data files.

It is also an object of the present invention to provide a mechanism for backing up data files which contain regions of sparse data.

It is a further object of the present invention to provide a mechanism for reading and writing large and/or sparse data files.

It is a still further object of the present invention to provide a mechanism which permits a greater degree of user control over the reading, writing and backing up of large and/or sparse files in a data processing system.

It is also an object of the present invention to provide parallel access to a file, both parallel within a single machine and parallel between machines.

It is still another object of the present invention to provide the ability for an extended read call to have a range specifier which is used to terminate read operations when the file is read in parallel particularly so as to allow the file to be partitioned and to be read in parallel.

It is yet another object of the present invention to provide general application users with more efficient tools for handling data files containing large regions of zero values.

It is still another object of the present invention to improve the operation of file systems by avoiding the allocation of blocks of data associated with sparse regions of a file.

It is also an object of the present invention to provide file system data structures which facilitate more efficient handling of large and/or sparse data files.

Lastly, but not limited hereto, it is an object of the present invention to enhance file system capabilities by extending certain functions into the realm of general users.

The recitation herein of a list of desirable objects which are met by various embodiments of the present invention is not meant to imply or suggest that any or all of these objects are present as essential features, either individually or collectively, in the most general embodiment of the present invention or in any of its more specific embodiments.

### DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following description taken in connection with the accompanying drawings in which:

FIG. 1 is a block diagram illustrating file system structures exploited by the present invention;

FIG. 2 is a block diagram illustrating the structure of two additional structures employable in conjunction with rapid and efficient backup operations which are usable in a form which permits both the retrieval of large blocks of data structure descriptions and which also permits partitioning of the backup task into a plurality of independent operations;

FIG. 3 is a block diagram illustrating a data structure usable in a file system directory for distinguishing files and directory or subdirectory entries;

FIG. 4 is a block diagram illustrating a file system data structure usable with the present invention particularly for small files;

FIG. 5 is a block diagram similar to FIG. 4 but more particularly indicating a file system data structure useful for large files where indirect pointers are employed;

FIG. 6A is a block diagram of a before hand view of a file system data structure employing “dirty bit” indicators;

FIG. 6B is a view similar to FIG. 6A except that it shows an “after” view;

FIG. 7A is a view similar to FIG. 6A;

FIG. 7B is a block diagram view illustrating the use of dirty bit data indicators for keeping track of what blocks of data are new and for indicating the presence of a new sparse region of data;

FIG. 8A is a block diagram illustrating file system status following the execution of a file system snapshot operation; and

FIG. 8B is a block diagram similar to FIG. 8B but more particularly illustrating the taking of a file system snapshot at a slightly different point in time.

### DETAILED DESCRIPTION OF THE INVENTION

### File System Background

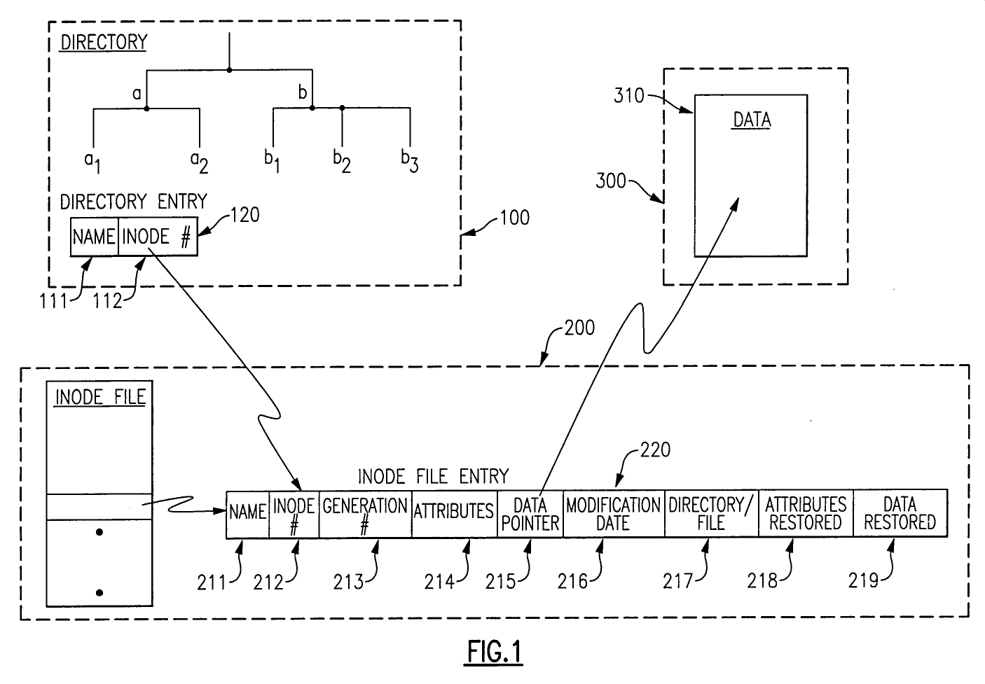

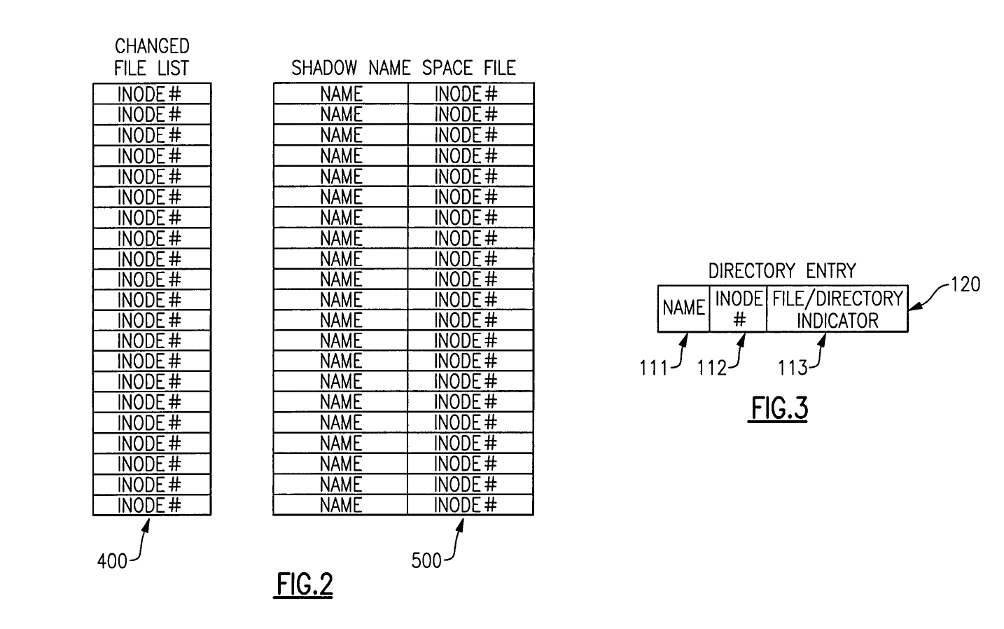

FIG. 1 illustrates the principle elements in a file system. A typical file system, such as the one shown, includes directory tree 100, inode file 200 and data 300. These three elements are typically present in a file system as files themselves. For example as shown in FIG. 1, inode file 200 comprises a collection of individual records or entries 220. There is only one inode file per file system. In particular, it is the one shown on the bottom of FIG. 1 and indicated by reference numeral 200. Entries in directory tree 100 include a pointer, such as field 112, which preferably comprises an integer quantity which operates as a simple index into inode file 200. For example, if field 112 contains a binary integer representing, say “10876,” then it refers to the 10876^{th} entry in inode file 200. Special entries are employed (see reference numeral 216 discussed below) to denote a file as being a directory. A directory is thus typically a file in which the names of the stored files are maintained in an arbitrarily deep directory tree. With respect to directory 100, there are three terms whose meanings should be understood for a better understanding of the present invention. The directory tree is a collection of directories which includes all of the directories in the file system. A directory is a specific type of file, which is an element in the directory tree. A directory is a collection of pointers to modes which are either files or directories which occupy a lower position in the directory tree. A directory entry is a single record in a directory that points to a file or directory. In FIG. 1, an exemplar directory tree is illustrated within function block 100. An exemplar directory entry contains elements of the form 120, as shown; but see also FIG. 3 for an illustration of a directory entry content for purposes of the present invention. While FIG. 1 illustrates a hierarchy with only two levels (for purposes of convenience) it should be understood that the depth of the hierarchical tree structure of a directory is not limited to two levels. In fact, there may be dozens of levels present in any directory tree. The depth of the directory tree does, nevertheless, contribute to the necessity of multiple directory references when only one file is needed to be identified or accessed. However, in all cases the “leaves” of the directory tree are employed to associate a file name (reference numeral 111) with entry 220 in inode file 200. The reference is by “inode number” (reference numeral 112) which provides a pointer into inode file 200. There is one inode array in file systems of the type considered herein. In preferred embodiments of the present invention, the inode array is inode file 200 and the index points to the array element. Thus, inode #10876 is the 10876^{th} array element in inode file 200. Typically, and preferably, this pointer is a simple index into inode file 200 which is thus accessed in an essentially linear manner. Thus, if the index is 108767, this points to the 10876^{th} record or array element of inode file 200. Name entry 111 allows one to move one level deeper in the tree. In typical file systems, name entry 111 points to, say inode #10876, which is a directory or a data file. If it is a directory, one recursively searches in that directory file for the next level of the name. For example, assume that entry 111 is “a,” as illustrated in FIG. 1. One would then search the data of inode #10876 for the name entry with the inode for “a2.” If name entry 111 points to data, one has reached the end of the name search. In the present invention, name entry 111 includes an additional field 113 (See FIG. 3) which indicates whether this is a directory or not. The directory tree structure is included separately because POSIX allows multiple names for the same file in ways that are not relevant to either the understanding or operation of the present invention.

Directory tree 100 provides a hierarchical name space for the file system in that it enables reference to individual file entries by file name, as opposed to reference by inode number. Each entry in a directory point to an inode. That inode may be a directory or a file. Inode 220 is determined by the entry in field 112 which preferably is an indicator of position in inode file 200. Inode file entry 220 in inode file 200 is typically, and preferably, implemented as a linear list. Each entry in the list preferably includes a plurality of fields: inode number 212, generation number 213, individual file attributes 214, data pointer 215, date of last modification 216 and indicator field 217 to indicate whether or not the file is a directory. Other fields not of interest or relevance to the present invention are also typically present in inode entry 220. However, the most relevant field for use in conjunction with the present invention is field 216 denoting the date of last modification. The inode number is unique in the file system. The file system preferably also includes generation number 213 which is typically used to distinguish a file from a file which no longer exists but which had the same inode number when it did exist. Inode field 214 identifies certain attributes associated with a file. These attributes include, but are not limited to: date of last modification; date of creation; file size; file type; parameters indicating read or write access; various access permissions and access levels; compressed status; encrypted status; hidden status; and status within a network. Inode entry 220 also includes entry 216 indicating that the file it points to is in fact a directory. This allows the file system itself to treat this file differently in accordance with the fact that it contains what is best described as the name space for the file system itself. Most importantly, however, typical inode entry 220 contains data pointer 215 which includes sufficient information to identify a physical location for actual data 310 residing in data portion 300 of the file system.

### Specific Approach for Large and/or Sparse Files

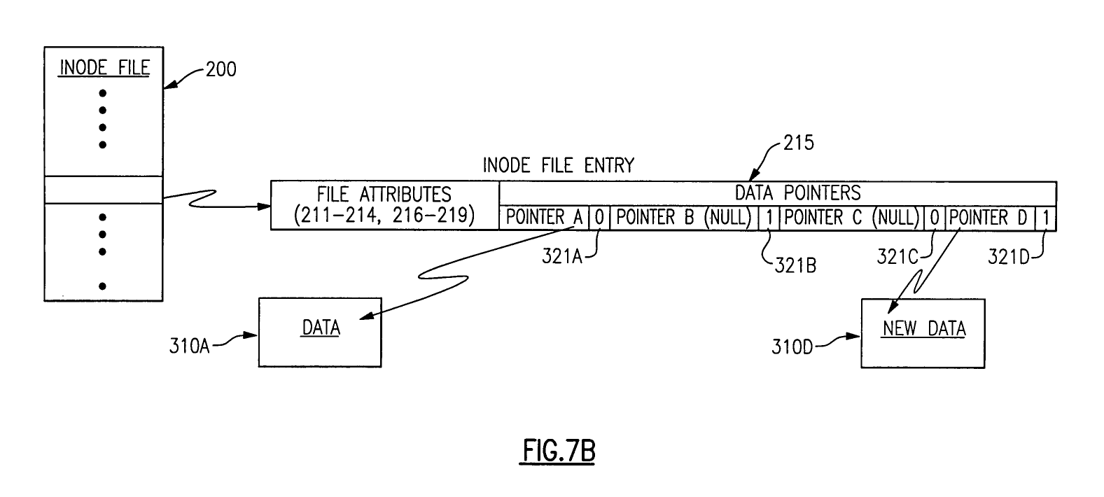

Most X-Open file systems have a file structure such as the one described above in which individual files are described in “inode” entries in a file called an “inode” file. The inode contains various file attributes, such as its creation time, file size, access permission, et cetera, as described above. The data for the file is stored in a separate disk block and is located by disk addresses and/or pointers stored in the file's inode. While the present invention is usable with files of any size its advantages are optimal for larger files. Typically, larger files are those for which the inode data points, not directly to data, but rather to indirect blocks which may themselves point at data or instead point to yet other indirect blocks; clearly, however, pointers to actual data are eventually present in the chain. (See the text “The Design and Implementation of the 4.3 BSD UNIX Operating System”, by Samuel J. Leffler, Marshall Kirk McKusick, Michael J. Kerels, John S. Quaterman, Addison-Wesley Publishing Company, Inc., May 1989, ISBN 0-201-06196-1, Section 7.2, pages 193-195 and, in particular, FIG. 7.6 therein further illustrating inodes, indirect blocks, and data blocks.) When non-zero data is written to a file, the file system allocates a data block for the data, then inserts the block's disk address into the inode or indirect block corresponding to the data's offset (typically and preferably an offset from the beginning of the file). The file system does not allocate data blocks for unwritten areas. Instead, the file system recognizes the so-called “null” disk address as a hole in the file and supplies zeroes to the regular read request to that area. Repeated writes to the same block do not necessarily require the file system to allocate a new block. Instead the file system overwrites existing data. The user may also set the length of the file, thus causing data blocks to be de-allocated.

Changes to a file are readily detected via the changes to the data block pointers or via write requests to an existing data block. There are a variety of ways to record these changes as discussed below. The method of the present invention employs a timestamp mechanism, as defined above, to insure that file changes are considered during backup operations. The use of a time stamp limits the granularity between backup requests. To support an incremental copy, the file system should do two things: first, it should be able to detect changes to a file, and second, it should have some notion of time to determine precisely the changes that have occurred during the requested increment.

In one embodiment of the present invention, the file system maintains the timestamp as a single “dirty” bit for each disk block assigned to the file. This bit provides an indication that the disk block does not currently contain valid data. The dirty bit may be stored within the inode file entry and/or within indirect blocks along with the disk pointers. Allocating or de-allocating a disk block as well as writing to an existing block sets the dirty bit. The extended read command of the present invention accesses the dirty bits to determine the changes and to reset the bits as the data is copied. For example, consider the situation in which the data is being read by a backup utility. The first time the backup utility runs, it copies all of the non-zero data and resets all of the dirty bits. The data is copied to another location, perhaps to a tape or to another file system located elsewhere. The next time the backup utility runs, it needs to read only the data that has changed since the first, original copy. The blocks that have changed are identified via the dirty bit. While reading the data, the dirty bits are reset and thus the file is ready to collect the changes for the next incremental backup. This embodiment, since it uses only a single dirty bit, limits the incremental changes to a single backup.

An improved embodiment of the present invention supports a timestamp with more than one dirty bit per data block address. This allows the user to obtain changes from more than one backup time period. A file system which maintains a monotonically increasing Log Sequence Number (LSN) is thus enabled to maintain a complete history of updates for the file.

An embodiment that replicates the inode for each backup period, like that discussed in U.S. Pat. 5,761,677 titled “Computer System Method and Apparatus Providing for Various Versions of a File Without Requiring Data Copy or Log Operations,” would also serve to identify the changed blocks, by simply comparing the disk addresses for each offset in the different versions of the file. The time stamps correspond to the versions of the file maintained.

A preferred embodiment of the present invention utilizes a file system that supports snapshots, such as IBM's General Parallel File System (GPFS). The “copy-on-write” method used to maintain the snapshot also serves to identify the changed blocks in each file. The extended read command herein need only examine the intervening snapshots to determine the incremental changes to the file. In this case, timestamps are the snapshot identifiers provided by the user. A description of the use of timestamps and snapshots is found in previously filed patent applications also assigned to the same assignee herein, namely, International Business Machines, Inc. on Feb. 15, 2002, under the following Ser. Nos. 10/077,129; 10/077,201; 10/077,246; 10/077,320; 10/077,345; and 10/077,371.

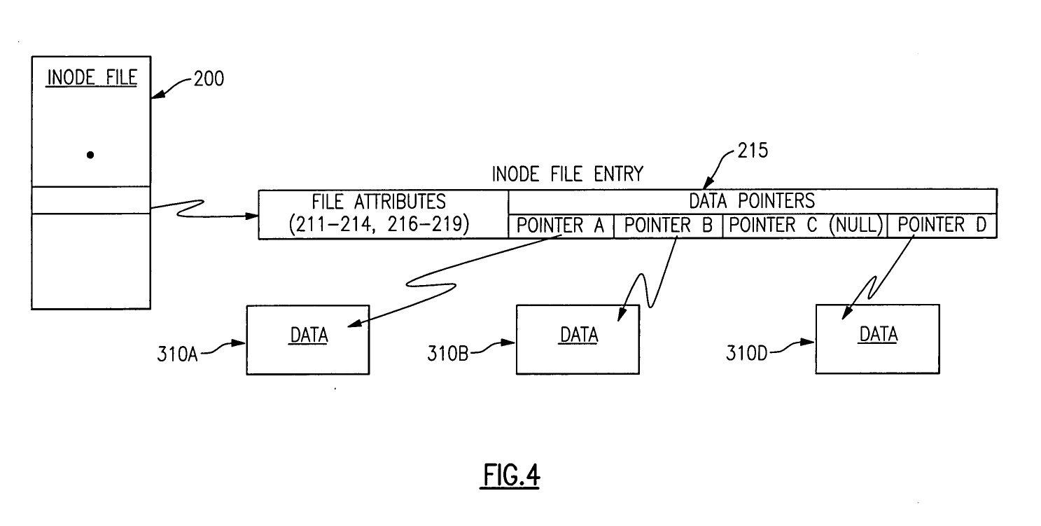

FIGS. 4 through 7B focus on the roll of the data pointers in the present invention and accordingly the other fields are lumped together for convenience and referred to collectively as “File Attributes. FIG. 4 depicts a file system data structure that would typically be employed for smaller files in which the pointers in the inode entry refer directly to storage areas. FIG. 4 thus is included to provide a more detailed view into field 215 of direct data pointers that is shown in FIG. 1. In particular, it is seen that field 215 typically includes pointers to several areas of non-zero data (310A, 310B and 310D). It is also seen that Pointer C in field 215 may contain a null value (or possibly other value) which provides an indication that the file contains an area of sparse data. File areas designated as having sparse data are advantageous in that storage areas do not have to be allocated for them. Also, it is noted that, as used herein, the term “sparse data” refers to the possibility that the file contains the same information in each byte, say for example, a hexadecimal “40” indicating a blank text character; while preferred embodiments of the present invention consider the sparse data portion to be zeroes, this characterization of the sparse data is not essential. The contiguous portion of a file containing only sparse data is referred to as a “sparse data region” or simply a “sparse region.” It is also to be noted that the term “sparse” also refers to regions of data in which each byte, or other atomic storage measure, contains the same information, as described below for the case in which textual as opposed to numeric data is stored. It is also noted that while the description herein typically contemplates the use of a byte of data as a standard of data atomicity, especially for zero values, other measures of atomicity are possible for use in conjunction with the present invention such as half bytes of data for hexadecimal values all the way up to double words for storing long floating point numbers.

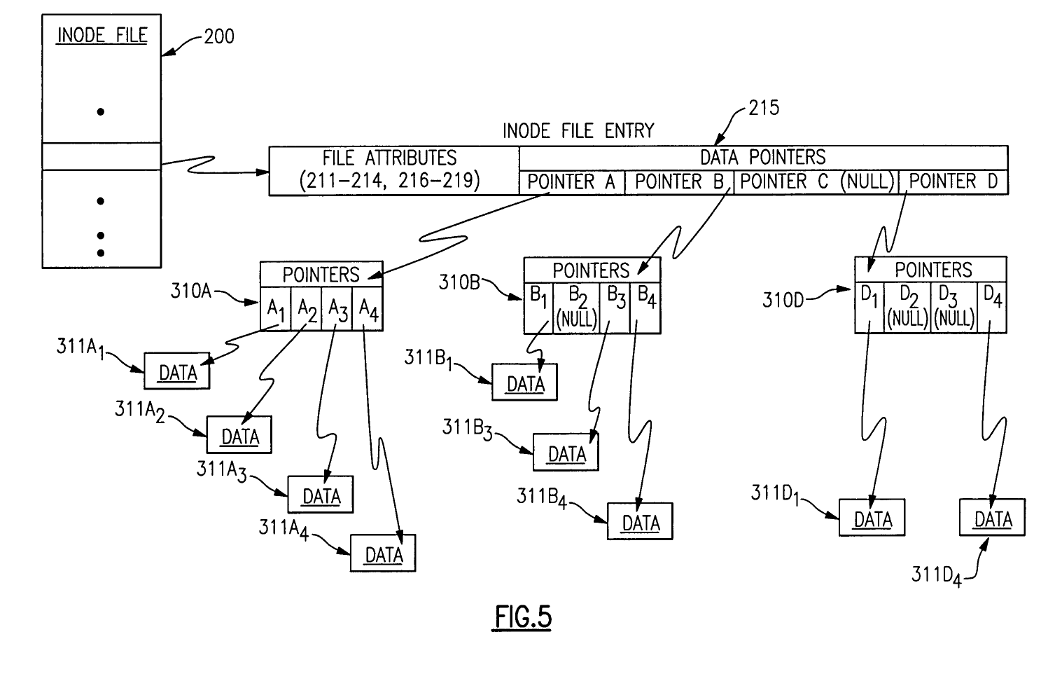

FIG. 5 is a view of a file system data structure similar to FIG. 4, but more applicable to larger files in which indirect pointers are employed. For example, it is seen that Pointer A in field 215 points to block 310A₁ which itself includes pointers A₁, A₂, A₃ and A₄, which point to data areas 311A₁, 311A₂, 311A₃ and 311A₄, respectively. Likewise this is the case for Pointer B for its respective indirect pointers, one of which, B₂, points to a sparse data region. Pointer C also points to a sparse region, which would typically be larger than the sparse region referenced by Pointer B₂. Pointer D is an indirect pointer to Pointers D₁, D₂, D₃ and D₄ (collectively referred to by reference numeral 310D₁). However, in this case Pointers D₂ and D₃ refer to regions of sparse data. Only Pointers D₁ and D₄ refer to non-sparse data, namely data in data regions 311D₁ and 311D₄. In this regard it is also noted that file systems do not typically store sparse data at the end of a file. File systems simply set the length of the file so that there is always non-zero data in the last byte of the file.

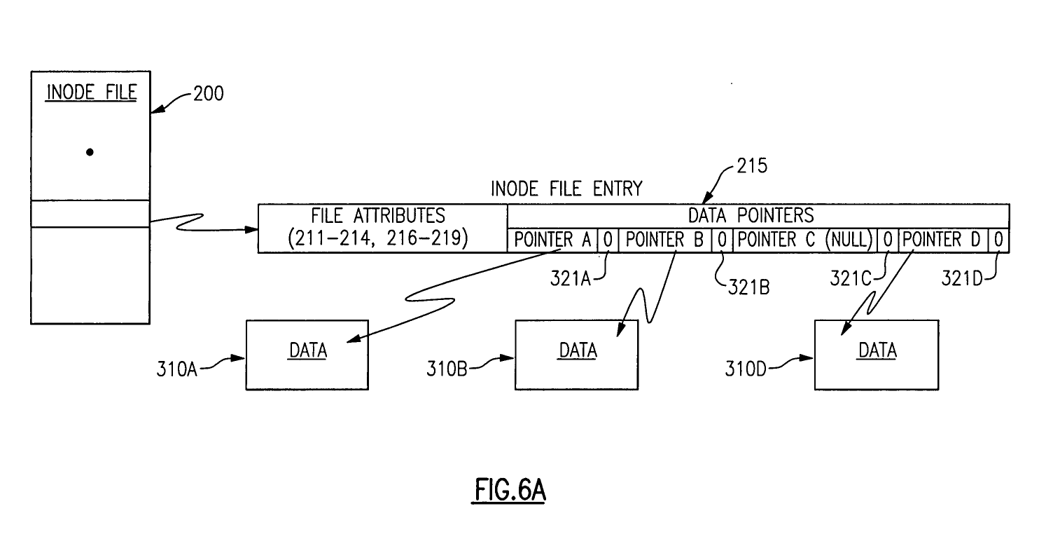

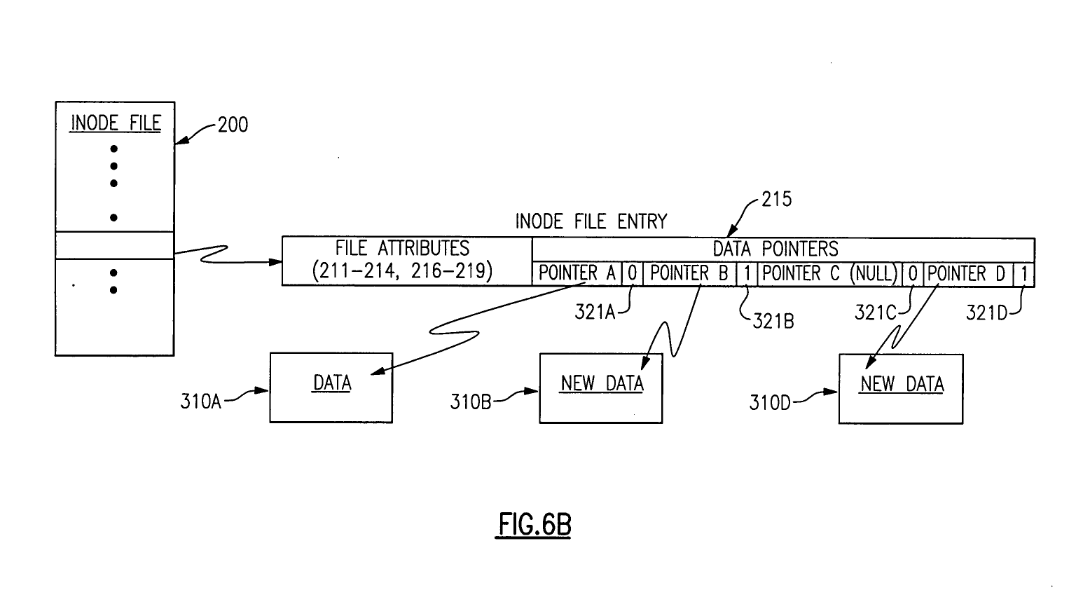

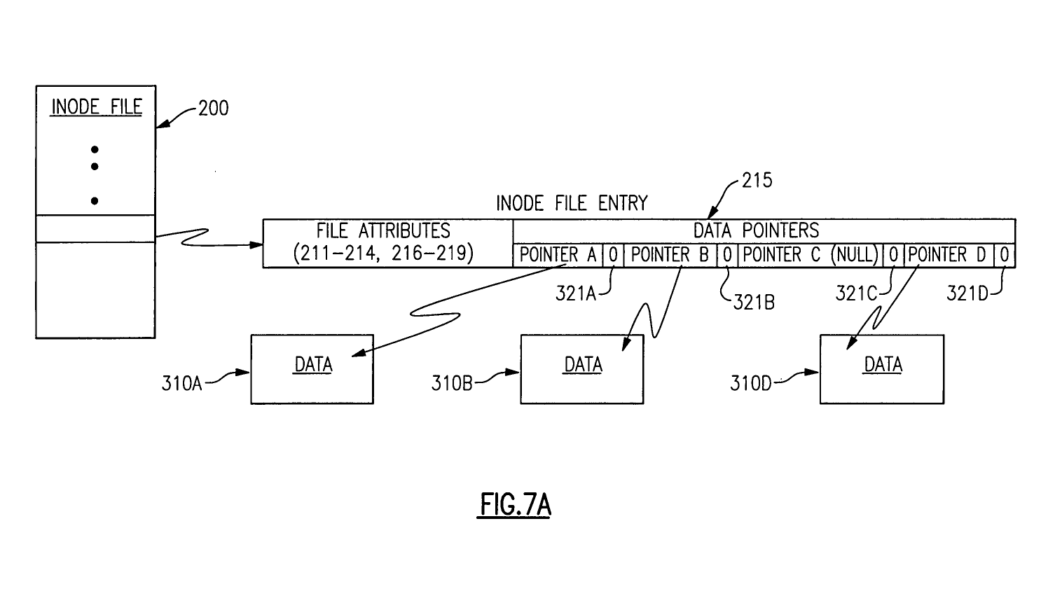

FIGS. 6A and 6B should be considered together since they represent, respectively, “before” and “after” pictures of file system data structure status. Even more particularly, FIGS. 6A and 6B illustrates the use of “dirty bit” indicators 321A, 321B, 321C and 321D as an example of one mechanism for controlling data status on a block-by-block basis, especially for file backup writing purposes. FIG. 6A shows an initial state in which all of the dirty bits are reset to zero meaning that the data has not been modified. FIG. 6B illustrates a file system data structure for the same file for the case in which new data has been written to data blocks 310B and 310D. In this case it is to be particularly noted that dirty bits 321B and 321D are now set at “1” to provide an indication that the data in the referenced blocks has been changed. Note that Pointer C still points to sparse data. In the example shown in FIGS. 6A and 6B, an extended read of the original “before” file returns the non-zero data in blocks 310A, 310B and 310D (since block 310C is null). An incremental read of the “after” file returns data for blocks 310B and 310D only.

While FIGS. 6A and 6B illustrate the situation for small files, where dirty bit indicators are present in inode file entry 215, it should also be appreciated that, for large files, the indicators of data “freshness” may also be provided within indirect blocks such as 310A, 310B and 310D shown in FIG. 5. Furthermore, dirty bit indicators could be replaced by any other timestamp mechanisms, for example a log sequence number (LSN). Any convenient change indicator may be employed on any sized file. It is not the case that small files use one technique and large files use another.

FIGS. 7A and 7B should also be considered together. These figures also show “before” and “after” views, respectively. Initially, all of the dirty bits are “clean.” However, FIG. 7B illustrates a scenario in which a new sparse region has been created and in which there is one new block of changed data. In particular, it is seen that Pointer B now reflects the fact that the previous data block (310B) is now sparse. Dirty bit 321B is set to “1” to reflect this change. At the same time, dirty bit 321D is set to “1” to reflect the fact that data block 310D has changed. In this example the “before” file has a hole in the third block (Pointer C) and data in blocks 310A, 310B and 310D. The drawings illustrates the situation that occurs if the file is truncated with respect to block 310B and new data is written to block 310D. Thus the “after” file now has a hole in blocks 310B and 310C, with the dirty bits set for pointers B and D only. An incremental read of the “after” file provides an indication that a new “hole” exists in block 310B and new non-zero data in block 310D. A backup program which takes full advantage of this information applies this increment to a previously saved version of the “before” file by using the extended write call to write the new “hole” for block 310B into a previously saved file. It then uses the extended write or a regular write to change block 310D, thus bring the saved backup file up-to-date.

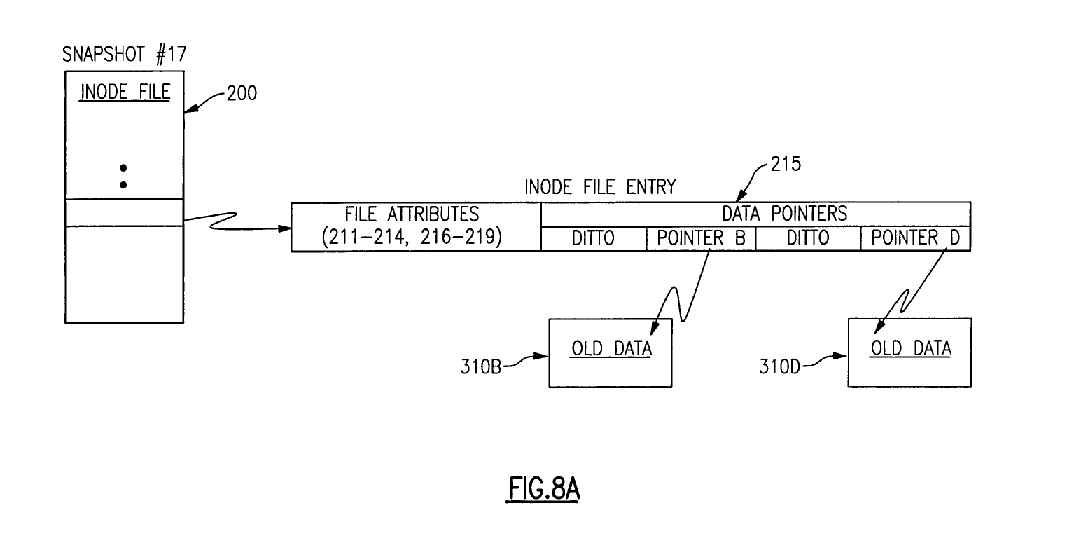

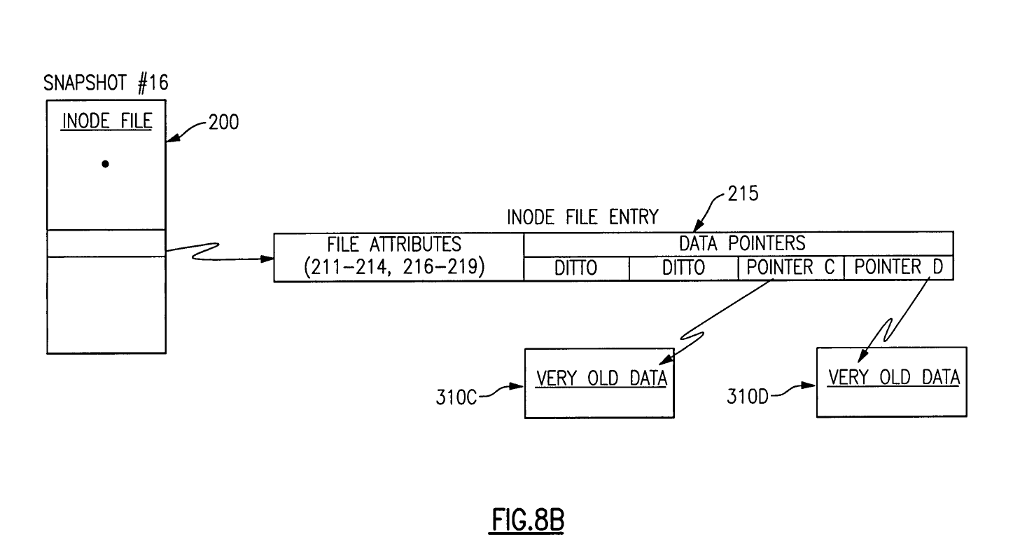

FIGS. 8A and 8B illustrate an embodiment of the present invention using a snapshot file system with “ditto” addresses rather than multiple references to a data block. (See the U.S. patent applications filed on Feb. 15, 2002, under the following Ser. Nos. 10/077,129; 10/077,201; 10/077,246; 10/077,320; 10/077,345; and 10/077,371.) Note that the entire inode for the file has been copied into the snapshot, as well as the data for two blocks (addressed by pointer B and D). Since the data stored in the other two blocks (A and C) has not changed, they refer to the data stored in a more recent snapshot (or the active file itself) using the reserved “ditto” address. The “ditto” addresses indicate blocks that have had no changes to their data during the snapshot interval and thus the snapshot “inherits” the data from a more recent snapshot or the active file. Note that the ditto addresses provide a mechanism to the extended read call to detect the changes to the active file since any snapshot or the changes to the file between any two snapshots.

The snapshots are of the file system shown in FIG. 6A or 7A, which are the same. Here, one file appears in the active file system (see FIG. 6A or 7A) and in two snapshots (numbered 17 and 16 in FIGS. 8A and 8B, respectively). The data blocks directly referenced here (via pointers C and D) are the only block which changed before the next snapshot was created (shown in FIG. 8A). In the active file system, the file contains three data blocks (310A, 310B and 310D in FIG. 6A or 7A) and all data blocks are directly addressed via the file's data pointers. In Snapshot #17 (in FIG. 8A), the file directly refers to two data blocks 310B and 310D, as shown. It also has a ditto address for blocks 310A and 310C indicating that the snapshot file contains the same data for those blocks as the next more recent snapshot/active file system. In this example, the file in Snapshot #17 has inherited data block 310A from the more recent file shown in FIG. 6A or 7A. In a like manner, the file also inherits the NULL address for block 310C indicating sparse data. Thus, the file in Snapshot #17 contains three data blocks, two that it addresses directly (310B and 310D) and one that it inherits via the ditto address (310A). The file in a prior Snapshot #16 (FIG. 8B) contains four data blocks. Blocks 310C and 310D are directly addressed by the file. The file also inherits data block 310A for the active file (since Snapshot #16 and Snapshot #17 both have a ditto for block 310A), and it inherits data block 310B from Snapshot #17 (since Snapshot #16 has a ditto, but Snapshot #17 has a data block). Note that the ditto addresses provide the mechanism for recording the incremental changes to a file. The presence of a ditto address in a snapshot file indicates that the data stored in that block has not changed during the snapshot increment. Thus, an incremental read of the changes to the active file system since Snapshot #17 returns only the data in blocks 310B and 310D. An incremental read of the changes to the active file system since Snapshot #16 returns the data in blocks 310B and 310D and furthermore indicates a new hole in data block 310C. The incremental read can also be applied between snapshot versions of the file. An incremental read of the changes to the file between Snapshot #17 and Snapshot #16 would return the data for blocks 310B and 310D only. Although not shown in the example, the incremental read can be applied to any pair of snapshots, regardless of the number of intervening snapshots.

In the preferred embodiment of the present invention which implements the extended read command, the null disk addresses in the file metadata serve to identify the zero data. The file system returns the flag indicating the data is zeroes and scans ahead in the inode and indirect blocks to locate the next allocated data block. This provides the size of the zero data to return to the caller. In an alternate embodiment, the file system scans the data in the allocated blocks being returned and sets the flag for any sufficient sequence of zeroes in the allocated data.

All of the methods described above to detect and record changes as well as sparse regions are fast and efficient. These methods are not heuristic solutions. Instead they exactly define the blocks that have changed. The extended read command determines the changed blocks by scanning the file's metadata and does not need to scan the actual file data. The preferred embodiment requires no additional storage for data signatures or time stamps, beyond the storage already required to implement the snapshot command. Since the file system already maintains this data, the extended calls merely provide a means for a general user to obtain the incremental changes to his own files. The method is also useable with the entire file system to support full backup or mirroring.

While the invention has been described in detail herein in accord with certain preferred embodiments thereof, many modifications and changes therein may be effected by those skilled in the art. Accordingly, it is intended by the appended claims to cover all such modifications and changes as fall within the true spirit and scope of the invention.

APPENDIX

| /* NAME: | gpfs_ireadx( ) | |
|---|---|---|
| * | | |
| * FUNCTION: | Block level incremental read on a file opened by gpfs_iopen | |
| * | with a given incremental scan opened via gpfs_open_inodescan. | |
| * | | |
| * Input: | ifile: | ptr to gpfs_file_t returned from gpfs_iopen( ) |
| * | iscan: | ptr to gpfs_iscan_t from gpfs_open_inodescan( ) |
| * | buffer: | ptr to buffer for returned data |
| * | bufferSize: | size of buffer for returned data |
| * | offset: | ptr to offset value |
| * | termOffset: | read terminates before reading this offset |
| * | caller may specify ia_size for the file's gpfs_iattr_t | |
| * | or 0 to scan the entire file. | |
| * | hole: | ptr to returned flag to indicate a hole in the |
| file | | |
| * | | |

| | |
|---|---|
| * Returns: | number of bytes read and returned in buffer |
| * | or size of hole encountered in the file. (Success) |
| * | −1 and errno is set (Failure) |
| * | |
| * | On input, *offset contains the offset in the file |
| * | at which to begin reading to find a difference same file |
| * | in a previous snapshot specified when the inodescan was |
| opened. | |
| * | On return, *offset contains the offset of the first |
| * | difference. |
| * | |
| * | On return, *hole indicates if the change in the file |
| * | was data (*hole == 0) and the data is returned in the |
| * | buffer provided. The function's value is the amount of data |
| * | returned. If the change is a hole in the file, |
| * | *hole != 0 and the size of the changed hole is returned |
| * | as the function value. |
| * | |
| * | A call with a NULL buffer pointer will query the next |
| increment | |
| * | to be read from the current offset. The *offset, *hole and |
| * | returned length will be set for the next increment to be read, |
| * | but no data will be returned. The bufferSize parameter is |
| * | ignored, but the termOffset parameter will limit the |
| * | increment returned. |
| * | |
| * Errno: | ENOSYS function not available |
| * | EINVAL missing or bad parameter |
| * | EISDIR file is a directory |
| * | EPERM caller must have superuser priviledges |
| * | ESTALE cached fs information was invalid |
| * | ENOMEM unable to allocate memory for request |
| * | EDOM fs snapId does match local fs |
| * | ERANGE previous snapId is more recent than scanned snapId |
| * | GPFS_E_INVAL_IFILE bad ifile parameter |
| * | GPFS_E_INVAL_ISCAN bad iscan parameter |
| * | see system call read( ) ERRORS |
| * | |
| * Notes: | The termOffset parameter provides a means to partition a |
| * | file's data such that it may be read on more than one node. |
| */ | |
| gpfs_off64_t | |

| | |
|---|---|
| gpfs_ireadx(gpfs_ifile_t *ifile, | /* in only */ |
| gpfs_iscan_t *iscan, | /* in only */ |
| void *buffer, | /* in only */ |
| int bufferSize, | /* in only */ |
| gpfs_off64_t *offset, | /* in/out */ |
| gpfs_off64_t termOffset, | /* in only */ |
| int *hole); | /* out only */ |

| /* NAME: | gpfs_iwritex( ) | | |
|---|---|---|---|
| * | | | |
| * FUNCTION: | Write file opened by gpfs_iopen. | | |
| * | If parameter hole == 0, then write data | | |
| * | addressed by buffer to the given offset for the | | |
| * | given length. If hole != 0, then write | | |
| * | a hole at the given offset for the given length. | | |
| * | | | |
| * Input: | ifile : | ptr to gpfs_file_t returned from gpfs_iopen( ) | |
| * | buffer: | ptr to data buffer | |
| * | writeLen: | length of data to write | |
| * | offset: | offset in file to write data | |
| * | hole: | flag | =1 to write a “hole” |
| * | | | =0 to write data |
| * | | | |

| | |
|---|---|
| * Returns: | number of bytes/size of hole written (Success) |
| * | −1 and errno is set (Failure) |
| * | |
| * Errno: | ENOSYS function not available |
| * | EINVAL missing or bad parameter |
| * | EISDIR file is a directory |
| * | EPERM caller must have superuser priviledges |
| * | ESTALE cached fs information was invalid |
| * | GPFS_E_INVAL_IFILE bad ifile parameter |
| * | see system call write( ) ERRORS |
| */ | |
| gpfs_off64_t | |

| | |
|---|---|
| gpfs_iwritex(gpfs_ifile_t *ifile, | /* in only */ |
| void *buffer, | /* in only */ |
| gpfs_off64_t writeLen, | /* in only */ |
| gpfs_off64_t offset, | /* in only */ |
| int hole); | /* in only */ |

The invention claimed is:

1. A method for performing block level incremental backup operations for a file, especially for a large and/or sparse file, said method comprising the steps of:
backing up said file to create a backup copy of said file;
processing a write request relevant to at least one block of said file by storing changes in information for said file and by providing an indication that information stored in said at least one block of said file is new data; and
backing up said file using at least one select block having said indication that information stored in said at least one block of said file is new data.

2. The method of claim 1 in which said indication is stored in inode data for said file.

3. The method of claim 1 in which said indication is stored in indirect blocks referenced by inode data for said file.

4. The method of claim 1 in which said backing up of at least one select blocks is further determined based on a time stamp associated with said at least one block.

5. The method of claim 4 in which said further determination is based on two such time stamps.

6. A method for retrieving incrementally backed up block level data, especially from large and/or sparse files, said method comprising the steps of:
providing two time stamps to a file system in a read request; and
returning information with respect to changes in said block made between times indicated by said two time stamps.

7. A method for backing up sparse files, said method comprising the step of:
writing to a backup file in a write request to a file system in which at least one user specified portion of said file is defined to have a specified value and in which the size of said at least one portion is specified by said user.

8. The method of claim 7 in which there are a plurality of said portions.

9. The method of claim 7 in which said specified value is zero.

10. The method of claim 8 in which said specified value is predetermined.

11. A method for performing block level incremental backup operations for a backed up file, especially for a large and/or sparse file, said method comprising the steps of:
processing a write request relevant to at least one block of said file by storing changes in information for said file and by providing an indication that information stored in said at least one block of said file is new data; and
backing up said file using at least one select block having said indication that information stored in said at least one block of said file is new data.

12. A computer readable medium having computer executable instructions for causing a data processor to perform block level incremental backup operations for a file, especially for a large and/or sparse file by carrying out the steps of:
backing up said file to create a backup copy of said file;
processing a write request relevant to at least one block of said file by storing changes in information for said file and by providing an indication that information stored in said at least one block of said file is new data; and
backing up said file using at least one select block having said indication that information stored in said at least one block of said file is new data.

13. A data processing system containing executable instructions, in memory locations of said data processing system, for causing said data processing system to perform block level incremental backup operations for a file by carrying out the steps of:
backing up said file to create a backup copy of said file;
processing a write request relevant to at least one block of said file by storing changes in information for said file and by providing an indication that information stored in said at least one block of said file is new data; and
backing up said file using at least one select block having said indication that information stored in said at least one block of said file is new data.
